(19) United States
(12) Patent Application Publication
(10) Pub. No.: US 2013/0195251 A1
(43) Pub. Date: Aug. 1, 2013

(54) X-RAY IMAGING APPARATUS, INFORMATION PROCESSING APPARATUS, METHODS OF CONTROLLING THE SAME, AND STORAGE MEDIUM

(71) Applicant: CANON KABUSHIKI KAISHA, Tokyo (JP)

(72) Inventors: Akio Saigusa, Tama-shi (JP); Tadahiko Iijima, Yokohama-shi (JP)

(73) Assignee: CANON KABUSHIKI KAISHA, Tokyo (JP)

(21) Appl. No.: 13/743,379

(22) Filed: Jan. 17, 2013

(30) Foreign Application Priority Data
Jan. 26, 2012 (JP) 2012-014580

(51) Int. Cl. H05G 1/30

(52) U.S. Cl. CPC H05G 1/30
USPC 378/101

(57) ABSTRACT

An X-ray imaging apparatus comprises: a wireless communication unit configured to communicate with a control apparatus; a measurement unit configured to measure first and second wireless parameters representing a wireless communication environment; a movement stop detection unit configured to detect a movement stop of the X-ray imaging apparatus based on a temporal variation in the first wireless parameter; a wireless environment determination unit configured to determine one of stability and instability of the wireless communication environment based on a temporal variation in the second wireless parameter; and an output unit configured to output, to the control apparatus, a signal to prohibit an X-ray generation apparatus connected to the control apparatus from performing exposure based on a detection result of the movement stop detection unit and a determination result of the wireless environment determination unit.

### BACKGROUND OF THE INVENTION

1. Field of the Invention

The present invention relates to an X-ray imaging apparatus, an information processing apparatus, methods of controlling the same, and a storage medium and, more particularly, to an X-ray imaging apparatus that digitizes a captured X-ray image by A/D conversion and transmits the digitized X-ray image data by wireless communication, an information processing apparatus, methods of controlling the same, and a storage medium.

2. Description of the Related Art

Conventionally, digital X-ray imaging apparatuses, which digitize an X-ray image captured by an X-ray imaging apparatus and perform image processing for the digitized X-ray image to generate a clearer X-ray image, have gone commercial. In general, X-ray imaging is performed by stationarily installing the X-ray imaging apparatus on a gantry or a bed. In some cases, the X-ray imaging apparatus is not mechanically fixed but set in a free position state for X-ray imaging in a higher degree of freedom. To meet such needs, some of the commercially available digital X-ray imaging apparatuses have been improved to a wireless type to increase the degree of freedom for installation.

For example, as shown in FIG. 5, an operator 14 inputs, to a control PC 11, patient information such as the ID, name, and date of birth of a patient 15 and the imaging part information of the patient 15. After inputting the imaging part information, the operator 14 fixes the posture of the patient 15 and the position of an X-ray imaging apparatus 3.

When preparation for imaging has finished, the operator 14 presses an X-ray irradiation switch 13. When the X-ray irradiation switch 13 is pressed, an X-ray generation apparatus 8 irradiates the patient 15 with X-rays in an X-ray room 1. The emitted X-rays pass through the patient 15 and enter the X-ray imaging apparatus 3.

The X-ray imaging apparatus 3 converts the X-rays into visible light and detects it as an X-ray image signal by a photoelectric conversion element. The X-ray imaging apparatus 3 drives the photoelectric conversion element to read the X-ray image signal. Then, an A/D conversion circuit converts the analog signal into a digital signal to obtain digital X-ray image data. The obtained digital X-ray image data is transferred from the X-ray imaging apparatus 3 to the control PC 11 via a synchronous access point 6.

The control PC 11 performs image processing for the received digital X-ray image data. The control PC 11 displays an X-ray image based on the processed X-ray image data on a display 12 (display apparatus).

The digital X-ray imaging operation from giving of an imaging instruction to the X-ray imaging apparatus by the operator 14 up to display of the X-ray image of the patient 15 on the display 12 has been describe above.

In the wireless digital X-ray imaging, digital X-ray image data and control commands of the X-ray imaging apparatus 3 are exchanged between the X-ray imaging apparatus 3 and the synchronous access point 6 by wireless communication.

The wireless communication is performed using a radio wave in a predetermined frequency band. The radio wave propagates across a wide space. For this reason, if a radio wave output from another wireless device exists in the propagation range, the radio waves may interfere and lower the data rate of wireless communication.

When the ISM band is used as the wireless communication band, there are not only influence of radio waves output from wireless devices such as a wireless LAN device and a cordless telephone but also influence of noise output from devices such as microwave therapy equipment and a microwave oven. During the operations of these devices, wireless communication may be completely inexecutable.

If the wireless communication function is impaired, the digital X-ray imaging apparatus cannot be controlled. If the wireless communication function is impaired after the imaging operation, captured digital X-ray image data cannot be transferred to the control PC. If image transfer is impossible, no X-ray image can be obtained, and reimaging is necessary. Hence, the patient suffers unnecessary exposure. To solve this problem, International Publication No. 2006/103790 discloses a method of detecting a communication error by exchanging communication check signals with a moving destination such as an X-ray imaging room or an operating room or when making a reservation for imaging.

A wireless communication environment is greatly affected not only by noise generated by the operation of another wireless communication device or microwave therapy equipment but also by the positional relationship between the X-ray imaging apparatus and the access point or the presence/absence of shielding including the patient and the operator. That is, the wireless communication environment is not always stable, and an unstable state may occur causing wireless communication to frequently disconnect depending on the presence/absence of noise or shielding such as a human body in the vicinity; or, even if connection is established, the communication data rate may be very low.

In the method disclosed in International Publication No. 2006/103790, however, even if the communication environment is unstable at the time of communication check, this state is not determined as an error unless a communication error occurs. For this reason, even when the communication is unstable, the imaging operation can start.

When imaging is performed under a very unstable communication environment, image transfer may be impossible due to disconnection, and re-imaging may be required. Even if image transfer is possible, it takes a long time at a lower communication data rate. Hence, the operator needs to wait for a long time and cannot start the next imaging operation.

### SUMMARY OF THE INVENTION

In consideration of the above-described problems, the present invention provides a technique of preventing re-imaging or a long waiting time of image transfer due to a change in the wireless communication environment.

According to one aspect of the present invention, there is provided an X-ray imaging apparatus for communicating with a control apparatus, comprising: a wireless communication unit configured to communicate with the control apparatus; a measurement unit configured to measure a first wireless parameter and a second wireless parameter representing a wireless communication environment; a movement stop detection unit configured to detect a movement stop of the X-ray imaging apparatus based on a temporal variation in the first wireless parameter; a wireless environment determination unit configured to determine one of stability and instability of the wireless communication environment based on a temporal variation in the second wireless parameter; and an output unit configured to output, to the control apparatus, a signal to prohibit an X-ray generation apparatus connected to the control apparatus from performing exposure based on a detection result of the movement stop detection unit and a determination result of the wireless environment determination unit.

Further features of the present invention will be apparent from the following description of exemplary embodiments with reference to the attached drawings.

### BRIEF DESCRIPTION OF THE DRAWINGS

FIG. 1 is a block diagram showing an example of the schematic arrangement of an X-ray imaging system according to the first embodiment;

FIG. 2 is a flowchart showing the procedure of processing of an X-ray imaging apparatus from wireless environment parameter measurement to imaging prohibition command output according to the first embodiment;

FIG. 3 is a timing chart showing an example of a variation in the RSSI caused by movement;

FIG. 4 is a timing chart showing an example of a variation in the S/N ratio caused by the operation of another wireless device;

FIG. 5 is a schematic view showing an example of the schematic arrangement of a conventional digital X-ray imaging system of wireless type; and

FIG. 6 is a flowchart showing the procedure of processing of an X-ray imaging apparatus according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

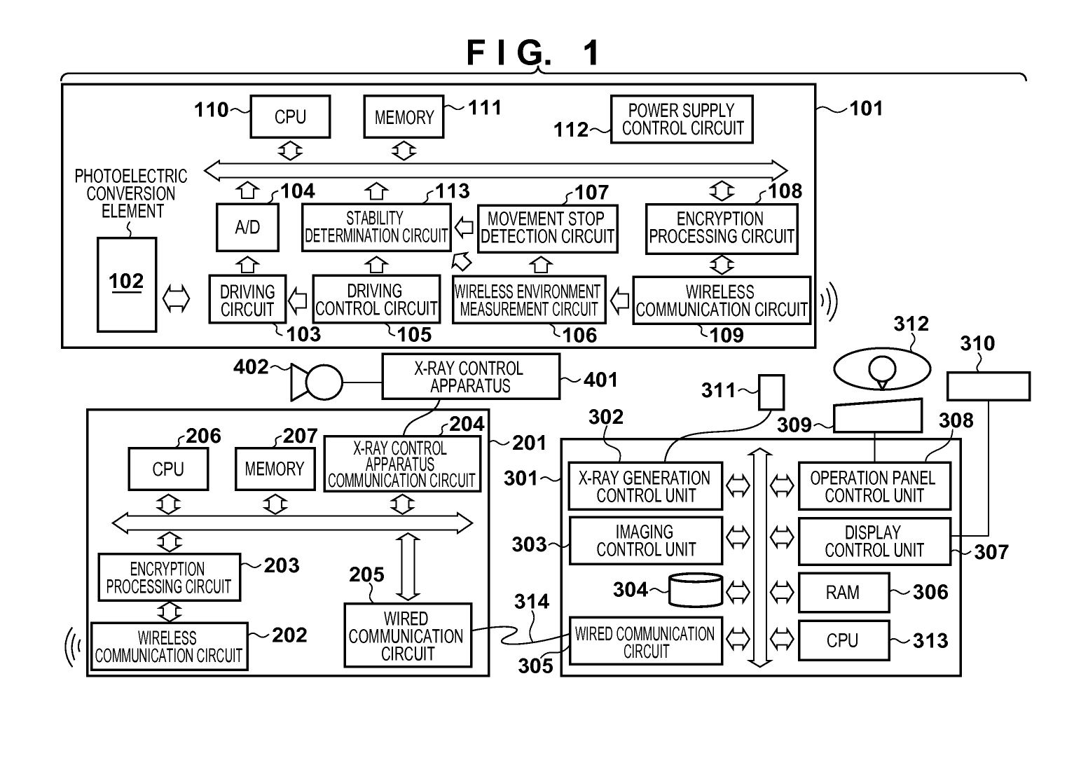

The schematic arrangement of an X-ray imaging system according to the first embodiment will be described with reference to FIG. 1. The X-ray imaging system includes an X-ray imaging apparatus 101, a synchronous access point 201, a control PC 301, an operation panel 309, a display 310 (display apparatus 310), an X-ray irradiation switch 311, a communication cable 314, an X-ray control apparatus 401, and an X-ray generation apparatus 402.

The X-ray imaging apparatus 101 detects X-rays emitted by the X-ray generation apparatus 402 and generates X-ray image data. The synchronous access point 201 sends the X-ray image data received from the X-ray imaging apparatus 101 to the control PC 301, and controls synchronization between the X-ray imaging apparatus 101 and the X-ray generation apparatus 402. The control PC 301 controls the operations of the X-ray imaging apparatus 101 and the X-ray control apparatus 401 based on instructions and the like from an operator 312. The X-ray control apparatus 401 controls the X-ray generation apparatus 402 based in instructions from the control PC 301. The X-ray generation apparatus 402 irradiates an object with X-rays under the control of the X-ray control apparatus 401.

The arrangement of each apparatus included in the X-ray imaging system will be described below in detail. Details of the X-ray imaging apparatus 101 will be described first. The X-ray imaging apparatus 101 includes a photoelectric conversion element 102, a driving circuit 103, an A/D conversion circuit 104, a driving control circuit 105, a wireless environment measurement circuit 106, a movement stop detection circuit 107, an encryption processing circuit 108, a wireless communication circuit 109, a CPU 110, a memory 111, a power supply control circuit 112, and a wireless environment stability determination circuit 113.

The photoelectric conversion element 102 is formed by two-dimensionally arraying a plurality of pixels (for example, 2688 pixels×2688 pixels with a resolution of 160 μm) and mainly made of amorphous silicon. The photoelectric conversion element 102 receives X-rays converted into visible light and detects it as an X-ray image signal. The photoelectric conversion element 102 is controlled by the driving circuit 103 to an accumulation state in which charges are accumulated or a non-accumulation state in which no charges are accumulated. Examples of the non-accumulation state in which no charges are accumulated are a sleep state in which no voltage is applied to the photoelectric conversion element 102, a sensor standby state in which a voltage is applied to the photoelectric conversion element 102, and a sensor read state in which the photoelectric conversion element 102 is driven, and an X-ray image signal is read.

The driving circuit 103 drives the photoelectric conversion element 102. The driving circuit 103 drives the photoelectric conversion element 102 to execute processing of reading an X-ray image signal. The A/D conversion circuit 104 converts the analog X-ray image signal read by the driving circuit 103 into a digital X-ray image signal and stores it in the memory 111 as X-ray image data. The driving control circuit 105 controls the driving circuit 103 based on an instruction from the imaging control unit 303 of the control PC 301, and outputs information representing whether the driving circuit 103 is in the accumulation state to the wireless environment stability determination circuit 113.

The wireless environment measurement circuit 106 measures one of an RSSI (Received Signal Strength Indication), an S/N ratio (Signal-Noise Ratio), and a data rate which are wireless communication environment parameters of wireless communication of the wireless communication circuit 109. The measured wireless communication environment parameter is output to the movement stop detection circuit 107 and the wireless environment stability determination circuit 113.

The movement stop detection circuit 107 monitors the position of the X-ray imaging apparatus 101 using the RSSI value output from the wireless environment measurement circuit 106, and detects whether the X-ray imaging apparatus is moving or has stopped moving. The detection result is output to the wireless environment stability determination circuit 113. The encryption processing circuit 108 encrypts communication data and outputs it to the wireless communication circuit 109 at the time of transmission, and decrypts encrypted communication data received by the wireless communication circuit 109 at the time of reception.

The wireless communication circuit 109 transmits encrypted communication data input from the encryption processing circuit 108 or outputs received communication data to the encryption processing circuit 108. The CPU 110 controls the entire X-ray imaging apparatus 101 using programs and various kinds of data stored in the memory 111. The memory 111 saves programs and various kinds of data to be used by the CPU 110 to execute processing. The memory 111 also saves various kinds of data and X-ray image data obtained by processing of the CPU 110.

The power supply control circuit 112 is formed from a battery and a DC/DC converter and supplies power to the respective circuits. The wireless environment stability determination circuit 113 determines the stability of the wireless communication environment based on the output results of the driving control circuit 105, the wireless environment measurement circuit 106, and the movement stop detection circuit 107. Note that the movement stop detection processing and the wireless environment stability determination processing may be executed by causing the CPU 110 to collect a wireless communication environment parameter and perform the same processing.

Details of the synchronous access point 201 will be described next. The synchronous access point 201 includes a wireless communication circuit 202, an encryption processing circuit 203, an X-ray control apparatus communication circuit 204, a wired communication circuit 205, a CPU 206, and a memory 207.

The wireless communication circuit 202 transmits encrypted communication data input from the encryption processing circuit 203, or outputs received communication data to the encryption processing circuit 203. The encryption processing circuit 203 encrypts communication data and outputs it to the wireless communication circuit 202 at the time of transmission, and decrypts encrypted communication data received by the wireless communication circuit 202 at the time of reception. The X-ray control apparatus communication circuit 204 communicates with the X-ray control apparatus 401 based on an instruction from an X-ray generation apparatus control unit 302 of the control PC 301. The wired communication circuit 205 manages communication of various kinds of data and various kinds of information between the synchronous access point 201 and the control PC 301. The CPU 206 controls the entire synchronous access point 201 using programs and various kinds of data stored in the memory 207. The memory 207 saves programs and various kinds of data to be used by the CPU 206 to execute processing. The memory 207 also saves various kinds of data and wireless communication data obtained by processing of the CPU 206.

Details of the control PC 301 will be described next. The control PC 301 includes the X-ray generation apparatus control unit 302, the imaging control unit 303, an external storage device 304, a wired communication circuit 305, a RAM 306, a display control unit 307, an operation panel control unit 308, and a CPU 313.

The X-ray generation apparatus control unit 302 controls the X-ray generation operation of the X-ray generation apparatus 402 based on an imaging instruction from the operator 312. The imaging control unit 303 performs control concerning X-ray imaging for the X-ray imaging apparatus 101 based on an imaging instruction from the operator 312. The external storage device 304 is formed from, for example, a hard disk and stores various kinds of programs and various kinds of data or various kinds of information.

The wired communication circuit 305 manages communication of various kinds of data and various kinds of information between the control PC 301 and the synchronous access point 201. The RAM 306 temporarily stores various kinds of data and various kinds of information necessary for processing of the control PC 301. The display control unit 307 performs various kinds of control concerning display of the display 310.

The operation panel control unit 308 performs various kinds of control concerning the operation panel 309 by, for example, switching display of the operation panel 309 in accordance with the operation of the operation panel 309 by the operator 312. The CPU 313 controls the entire control PC 301 using programs and various kinds of data stored in the RAM 306. Note that the communication cable 314 communicably connects the synchronous access point 201 and the control PC 301.

The control PC 301 is connected to the operation panel 309, the display 310, and the X-ray irradiation switch 311. The operation panel 309 accepts an input by the operator 312, and outputs the instruction input by the operator 312 to the control PC 301. The display 310 displays various kinds of images and information under the control of the display control unit 307. When the operator 312 operates and presses the X-ray irradiation switch 311, an imaging instruction is input to the X-ray generation apparatus control unit 302 and the imaging control unit 303, and X-ray imaging is performed.

The outline of processing of the X-ray imaging system will be explained next. When the operator 312 inputs the patient information and imaging part information of a patient using the operation panel 309, the imaging control unit 303 issues a sensor standby command to set the X-ray imaging apparatus 101 in the imaging standby state. The sensor standby command is transmitted to the synchronous access point 201 via the wired communication circuit 305 and the communication cable 314. Upon receiving the sensor standby command, the synchronous access point 201 causes the encryption processing circuit 203 to encrypt the command and causes the wireless communication circuit 202 to convert the command into a radio wave, thereby transmitting the sensor standby command to the X-ray imaging apparatus 101. Upon receiving the sensor standby command, the X-ray imaging apparatus 101 causes the driving control circuit 105 to change the driving circuit 103 from the sleep state to the sensor standby state. After transiting to the sensor standby state, the X-ray imaging apparatus 101 stands by for a predetermined time (for example, about 3 to 5 sec) to obtain an image with a small dark current and high S/N ratio.

The operator 312 fixes the posture of the patient during the standby time. At this time, the position of the X-ray imaging apparatus 101 is also fixed together with the patient. The operator 312 confirms that preparation for imaging has finished, and presses the X-ray irradiation switch 311. When the X-ray irradiation switch 311 is pressed, the X-ray imaging apparatus 101 changes the driving circuit 103 from the non-accumulation state to the accumulation state, and waits for X-ray irradiation. The X-ray generation apparatus 402 performs X-ray irradiation during the accumulation state of the X-ray imaging apparatus 101. The X-ray imaging apparatus 101 detects the X-ray image signal that has passed through the patient, changes the driving circuit 103 to the read state, and drives the photoelectric conversion element 102 to read the X-ray image signal. The A/D conversion circuit 104 converts the read analog signal into a digital signal and acquires digital X-ray image data. The acquired X-ray image data is stored in the memory 111. When the read of the X-ray image signal has ended, the X-ray imaging apparatus 101 changes the driving circuit 103 to the sleep state in which no voltage is applied to the photoelectric conversion element 102. The X-ray imaging operation of the X-ray imaging apparatus 101 is executed under the control of the CPU 110 and the driving control circuit 105 based on the imaging instruction from the control PC 301.

Note that the X-ray image data stored in the memory 111 is transmitted to the synchronous access point 201 via the encryption processing circuit 108 and the wireless communication circuit 109 of the X-ray imaging apparatus 101. The X-ray image data received by the synchronous access point 201 is transmitted to the control PC 301 via the wired communication circuit 205 and the communication cable 314. The control PC 301 stores the received X-ray image data in the internal RAM 306. After having undergone appropriate image processing, the X-ray image data stored in the RAM 306 is displayed on the display 310 and saved in the external storage device 304. To continuously perform imaging, the operator 312 starts the operation from patient information input or imaging part selection.

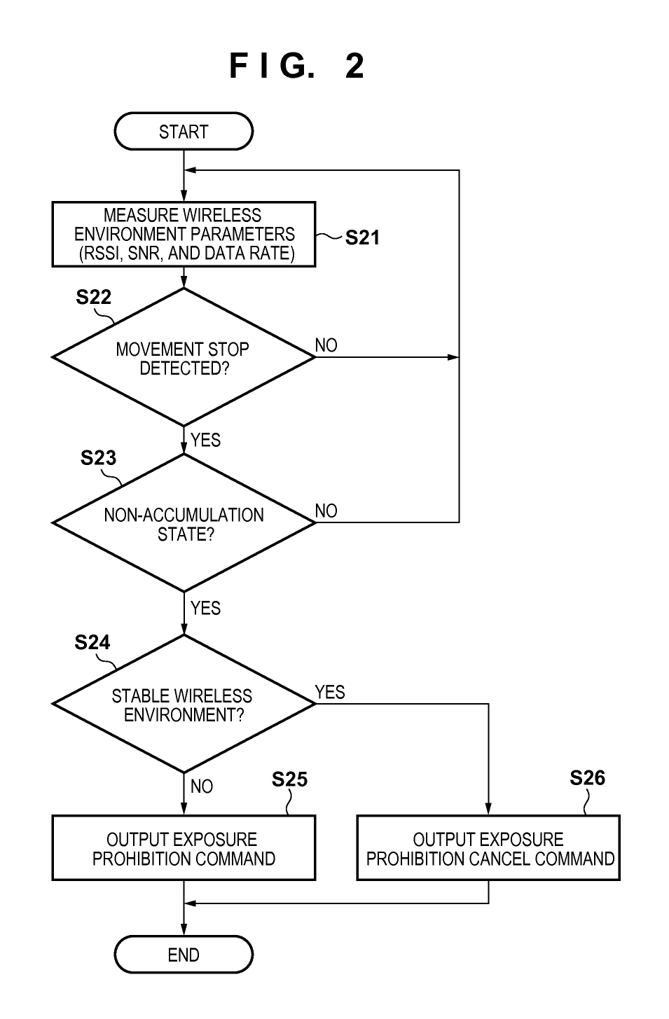

The procedure of processing the X-ray imaging apparatus 101 from wireless environment parameter measurement to imaging prohibition command output according to the first embodiment will be described with reference to the flowchart of FIG. 2.

In step S21, the wireless environment measurement circuit 106 periodically measures wireless environment parameters including the RSSI (first wireless parameter) and the S/N ratio or data rate (second wireless parameter). The measurement result of the RSSI of the wireless environment parameters is output to the movement stop detection circuit 107, and the measurement result of the S/N ratio or data rate is output to the wireless environment stability determination circuit 113.

In step S22, the movement stop detection circuit 107 detects, based on the measurement result of the RSSI value of the wireless environment parameters, whether the stop of the position of the X-ray imaging apparatus 101 has been detected. Upon determining that the stop of the position of the X-ray imaging apparatus 101 has been detected (YES in step S22), the process advances to step S23. Upon determining that a stop of the position of the X-ray imaging apparatus 101 has not been detected (NO in step S22), the process returns to step S21.

The method of detecting the stop of movement of the X-ray imaging apparatus 101 by the movement stop detection circuit 107 in step S22 will be described here. The RSSI that is one of the wireless environment parameters represents the received signal strength of a radio wave. The RSSI largely varies depending on the distance from the partner of wireless communication and the presence/absence of shielding including the patient and the operator.

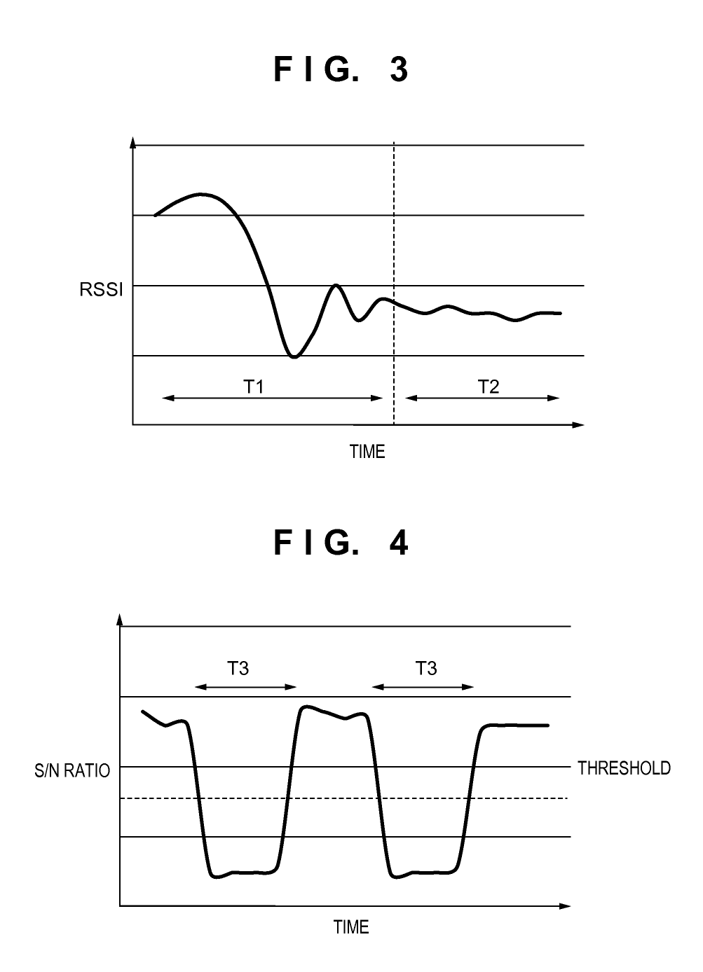

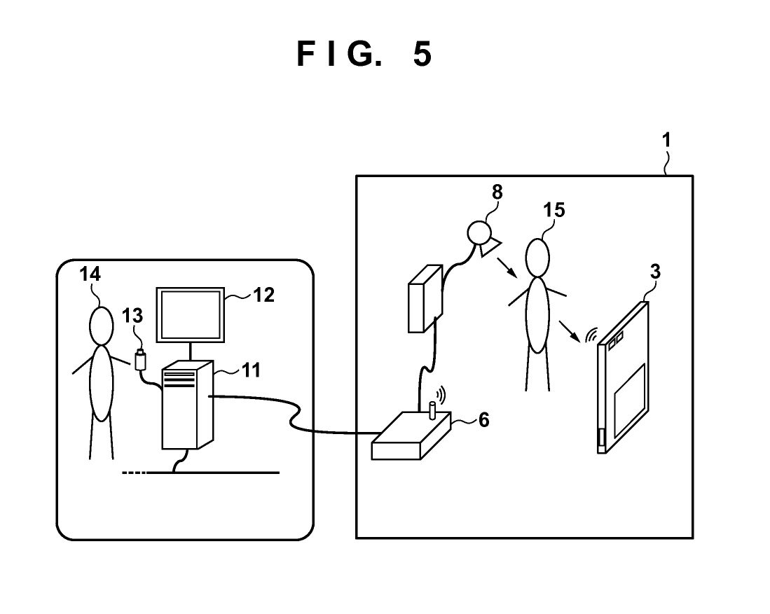

The RSSI measurement result obtained when the X-ray imaging apparatus 101 is moving or is at a standstill will be described with reference to FIG. 3. During a period T1, the X-ray imaging apparatus 101 is moving. During a period T2, the X-ray imaging apparatus 101 is at a standstill. As is apparent from FIG. 3, the temporal variation in the RSSI is large during the movement of the X-ray imaging apparatus 101. After the X-ray imaging apparatus 101 has stopped, the temporal variation in the RSSI is small. That is, monitoring the temporal variation in the RSSI makes it possible to detect the movement or stop of the X-ray imaging apparatus 101.

More specifically, RSSI measurement data is periodically collected. When the temporal variation in the RSSI has converged into a predetermined range, the X-ray imaging apparatus 101 is determined to have stopped moving. As for the movement stop determination method, for example, if the difference between the maximum value and the minimum value of the RSSI is equal to or smaller than a predetermined value during a predetermined period, the X-ray imaging apparatus 101 can be determined to be at a standstill during this period. Alternatively, the moving average of RSSI measurement data is calculated. If the calculated moving average and the difference between the maximum value and the minimum value of the RSSI used to calculate the moving average are equal to or smaller than predetermined values, the X-ray imaging apparatus 101 can be determined to be at a standstill during the measurement period of the RSSI used to calculate the moving average. Note that the movement stop determination method is not limited to those described above, and any other method is usable if it can detect that the temporal variation in the RSSI has converged into a predetermined range.

In step S23, the driving circuit 103 determines based on the output result of the driving control circuit 105 whether the photoelectric conversion element 102 is in the non-accumulation state (accumulation state determination processing). Upon determining that the photoelectric conversion element 102 is in the non-accumulation state (YES in step S23), the process advances to step S24. Upon determining that the photoelectric conversion element 102 is in the accumulation state (NO in step S23), the process returns to step S21. Note that the processing in step S23 is not always essential, and processing in step S24 may be executed after the processing in step S22.

In step S24, the wireless environment stability determination circuit 113 determines, based on the measurement result of the S/N ratio or data rate of the wireless environment parameters, whether the wireless environment is stable (wireless environment determination processing). Upon determining that the wireless environment is stable (YES in step S24), the process advances to step S26. Upon determining that the wireless environment is unstable (NO in step S24), the process advances to step S25.

The wireless environment stability determination method of the wireless environment stability determination circuit 113 in step S24 will be described here. The S/N ratio that is one of the wireless environment parameters represents the ratio of the signal power to the noise power of a received radio wave. The signal power corresponds to the RSSI, and the noise power corresponds to noise generated by a device in the vicinity. The communication speed and connection stability of wireless communication largely depend on the S/N ratio of the wireless environment parameters. When the S/N ratio lowers, the communication speed lowers. If the S/N ratio is equal to or less than a predetermined numerical value, wireless communication cannot be performed.

The measurement result of the temporal variation in the S/N ratio affected by noise from another wireless device in a state in which the temporal variation in the RSSI falls within a predetermined range, that is, in a state in which the X-ray imaging apparatus 101 is not moving will be described with reference to FIG. 4. During a period T3, the S/N ratio is affected by noise generated from another wireless device. Since the RSSI value is constant, the S/N ratio lowers by the amount of increase of noise. Under this wireless environment, the wireless connection is frequently disconnected, or the communication speed lowers. Hence, stable wireless communication is difficult to perform. When a wireless environment in which stable communication is difficult is measured, the wireless communication environment is determined to be unstable.

More specifically, in the state in which the RSSI falls within a predetermined range, if the ratio of a time where the S/N ratio falls below a threshold is equal to or more than a predetermined value, the wireless environment is determined to be unstable. The method of determining the stability of the wireless communication environment using the S/N ratio of the wireless environment parameters has been described above. However, the temporal variation in the data rate that is one of the wireless environment parameters may be used. The data rate represents the communication speed. When the S/N ratio lowers, the data rate lowers, too. For this reason, like the S/N ratio, if the ratio of a time where the data rate falls below a threshold is equal to or more than a predetermined value, the wireless environment can be determined to be unstable.

In step S25, the wireless environment stability determination circuit 113 outputs an exposure prohibition command to the control PC 301 if no command has been output or a previous exposure prohibition cancel command has been output. Note that when the previous exposure prohibition cancel command has been output, the processing ends without outputting a command.

In step S26, the wireless environment stability determination circuit 113 outputs an exposure prohibition cancel command to the control PC 301 if a previous exposure prohibition command has been output. Note that when the previous exposure prohibition cancel command has been output, the processing ends without outputting a command. The processing of the flowchart in FIG. 2 thus ends.

The above-described processing allows to discriminate between an S/N ratio degradation caused by movement of the X-ray imaging apparatus or shielding including the patient and the operator and an S/N ratio degradation caused by noise generated by the operation of another wireless communication device, microwave therapy equipment, or the like. Hence, the environment stability can accurately be determined.

When the wireless communication environment is determined to be unstable, an imaging prohibition command is output to the control PC. This allows the control PC to notify the operator that imaging is prohibited, and the wireless communication environment is unstable. The operator who has received the notification can respond by, for example, stopping the device that is generating noise or performing imaging using a cable insusceptible to noise. Hence, the operator can know before imaging that the wireless environment is unstable. This allows prevention of re-imaging or a long waiting time of image transfer due to a change in the wireless communication environment.

### Second Embodiment

Other than the above-described imaging method using an X-ray imaging apparatus in a free position state, there is also known a method of capturing a plurality of X-ray images using an X-ray imaging apparatus fixed to a table, an arm, or the like in synchronism with an X-ray generation apparatus.

Examples are “stitching” that captures a large area such as a spinal curvature or whole lower extremity, which cannot fit in the imaging range of an X-ray imaging apparatus, divisionally a plurality of times and bonds the captured images, and “computed tomography” that acquires X-ray images of an object from multiple angles while rotating an X-ray generation apparatus and X-ray imaging apparatus supported on an arm, and generates a 3D image by calculations based on the obtained X-ray images. There also exists “tomosynthesis” that performs X-ray imaging of an object from a plurality of directions while translating an X-ray imaging apparatus and an X-ray generation apparatus in reverse directions, and generates predetermined tomographic images from the obtained projected images.

In these imaging methods, the X-ray imaging apparatus performs imaging while moving. Hence, the wireless communication environment may vary in accordance with the movement, and prohibiting X-ray imaging based on the variation in the communication environment caused by the movement is problematic. In the second embodiment, even when the wireless communication environment is unstable, the exposure prohibition command is not output.

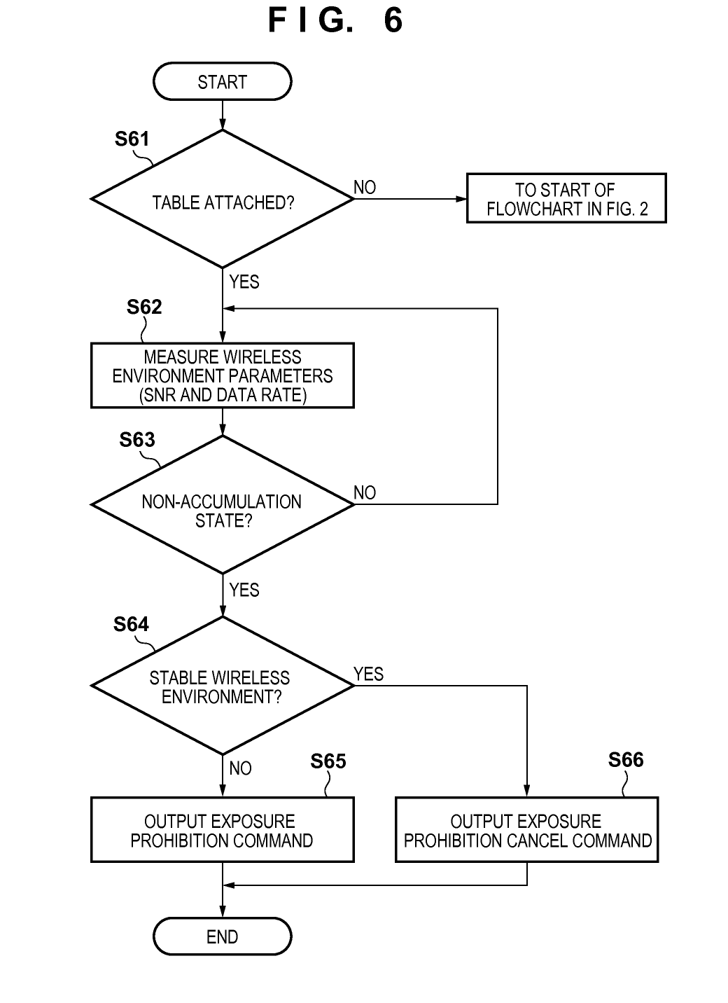

The procedure of processing of an X-ray imaging apparatus 101 according to the second embodiment will be described with reference to the flowchart of FIG. 6.

In step S61, the X-ray imaging apparatus 101 causes a detection circuit (not shown) to detect attachment to a table, an arm, or the like (moving mechanism capable of moving the X-ray imaging apparatus). The attachment detection is done by, for example, causing a magnetic sensor to detect the magnetic field of a magnet embedded in a table or an arm. If attachment is detected, the process advances to step S62. If attachment is not detected, the control is performed in accordance with the same procedure as in the first embodiment from then on.

In step S62, a wireless environment measurement circuit 106 periodically measures the S/N ratio or data rate (second wireless parameter). The measurement result of the S/N ratio or data rate is output to a wireless environment stability determination circuit 113.

In step S63, a driving circuit 103 determines based on the output result of a driving control circuit 105 whether a photoelectric conversion element 102 is in the non-accumulation state (accumulation state determination processing). Upon determining that the photoelectric conversion element 102 is in the non-accumulation state (YES in step S63), the process advances to step S64. Upon determining that the photoelectric conversion element 102 is in the accumulation state (NO in step S63), the process returns to step S62. Note that the processing in step S63 is not always essential, and processing in step S64 may be executed after the processing in step S62.

In step S64, the wireless environment stability determination circuit 113 determines, based on the measurement result of the S/N ratio or data rate of the wireless environment parameters, whether the wireless environment is stable (wireless environment determination processing). Upon determining that the wireless environment is stable (YES in step S64), the process advances to step S66. Upon determining that the wireless environment is unstable (NO in step S64), the process advances to step S65. The wireless environment stability determination method in step S64 is the same as in step S24. Processes in steps S65 and S66 are also the same as in steps S25 and S26.

The above-described processing allows to discriminate the wireless environment stability even in the system that performs imaging while moving the X-ray imaging apparatus.

In the above-described embodiments, the wireless environment determination is done after the movement stop detection. However, the present invention is not limited to this. The processing time can be shortened by parallelly executing the movement stop detection and the wireless environment determination. Note that the movement stop detection may be performed after the wireless environment determination. However, when performing the movement stop detection and the wireless environment determination based on the above-described temporal variation in the wireless communication parameters, performing the wireless environment determination after the variation in the wireless strength caused by the movement of the X-ray imaging apparatus has disappeared is advantageous in specifying the cause of a situation inappropriate for communication. For example, if the wireless environment is unstable after the movementstop detection, the operator can easily specify an electronic device other than the X-ray imaging apparatus as the cause of the error.

As described above, the X-ray imaging apparatus according to the present invention detects the movement stop of the X-ray imaging apparatus based on the temporal variation in the first wireless parameter, determines the wireless communication environment stability or instability based on the temporal variation in the second wireless parameter, and outputs, to the control apparatus, the signal to prohibit the X-ray generation apparatus connected to the control apparatus from performing exposure based on the movement stop detection result and the wireless environment stability or instability determination result. This allows prevention of re-imaging or a long waiting time of image transfer due to a change in the wireless communication environment.

### Third Embodiment

In the above-described example, radiographic imaging is prohibited when the wireless environment is unstable. However, the present invention is not limited to this. When the wireless environment is unstable, a warning may be displayed without prohibiting radiographic imaging. For example, an operation panel control unit 308 may display, on an operation panel 309, an icon indicating a warning or a warning message, for example, “Since the wireless environment is unstable, the system may fail to properly transfer images. If image transfer cannot be performed, connect a cable to the X-ray imaging apparatus and acquire the images”. In this case, an X-ray imaging apparatus 101 is provided with a connector to connect a cable, and a wired communication unit that transfers an X-ray image via the cable in accordance with connection of the cable to the connector. This allows execution of X-ray imaging and confirmation of an X-ray image even if the wireless environment is unstable, and advantageously accommodates a case in which, for example, imaging is needed urgently.

Note that in the above embodiments, the description has been made assuming that mainly the X-ray imaging apparatus 101 executes each operation. However, the X-ray imaging apparatus 101 need not always execute the operations. As an information processing apparatus for controlling the operation of the X-ray imaging system, the synchronous access point 201, the control PC 301, or the X-ray control apparatus 401 may execute the above-described processing in addition to the X-ray imaging apparatus 101. The information processing apparatus controls the operation of the X-ray imaging system that wirelessly transmits X-ray image data obtained by the X-ray imaging apparatus 101 to the display 12 (display apparatus), and has a function of detecting parameters representing the wireless communication environment, and a function of outputting a signal to restrict X-ray generation by the X-ray generation apparatus 402 based on temporal variations in the detected parameters. This allows restriction of radiographic imaging when the wireless environment is unstable.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-014580 filed on Jan. 26, 2012, which is hereby incorporated by reference herein in its entirety.

What is claimed is:

1. An X-ray imaging apparatus for communicating with a control apparatus, comprising:
a wireless communication unit configured to communicate with the control apparatus;
a measurement unit configured to measure a first wireless parameter and a second wireless parameter representing a wireless communication environment;
a movement stop detection unit configured to detect a movement stop of the X-ray imaging apparatus based on a temporal variation in the first wireless parameter;
a wireless environment determination unit configured to determine one of stability and instability of the wireless communication environment based on a temporal variation in the second wireless parameter; and
an output unit configured to output, to the control apparatus, a signal to prohibit an X-ray generation apparatus connected to the control apparatus from performing exposure based on a detection result of said movement stop detection unit and a determination result of said wireless environment determination unit.

2. The apparatus according to claim 1, wherein
when said movement stop detection unit has detected the movement stop, said wireless environment determination unit determines one of the stability and the instability of the wireless communication environment based on the temporal variation in the second wireless parameter, and
when said wireless environment determination unit has determined that the wireless communication environment is unstable, said output unit outputs, to the control apparatus, the signal to prohibit the X-ray generation apparatus connected to the control apparatus from performing exposure.

3. The apparatus according to claim 1, further comprising an accumulation state determination unit configured to determine whether a photoelectric conversion element included in the X-ray imaging apparatus is in a non-accumulation state in which no charges are accumulated,
wherein when said movement stop detection unit has detected the movement stop, and said accumulation state determination unit has determined that the photoelectric conversion element is in the non-accumulation state, said wireless environment determination unit determines one of the stability and the instability of the wireless communication environment based on the temporal variation in the second wireless parameter.

4. The apparatus according to claim 1, wherein the first wireless parameter is a received signal strength, and the second wireless parameter is one of an S/N ratio and a data rate.

5. The apparatus according to claim 4, wherein said movement stop detection unit detects the movement stop of the X-ray imaging apparatus by detecting that a temporal variation in the received signal strength has converged into a predetermined range.

6. The apparatus according to claim 4, wherein
when said movement stop detection unit has detected the movement stop, said wireless environment determination unit determines that the wireless communication environment is unstable if a ratio of a period where one of the S/N ratio and the data rate is less than a threshold is more than a predetermined value, and determines that the wireless communication environment is stable if the ratio of the period where one of the S/N ratio and the data rate is less than the threshold is not more than the predetermined value.

7. The apparatus according to claim 1, further comprising a detection unit configured to detect that the X-ray imaging apparatus is attached to a moving mechanism configured to move the X-ray imaging apparatus,
wherein when said detection unit has not detected the attachment,
said output unit outputs, to the control apparatus, the signal to prohibit the X-ray generation apparatus connected to the control apparatus from performing exposure based on the detection result of said movement stop detection unit and the determination result of said wireless environment determination unit, and
when said detection unit has detected the attachment,
said output unit outputs, to the control apparatus, the signal to prohibit the X-ray generation apparatus connected to the control apparatus from performing exposure based on the determination result of said wireless environment determination unit.

8. An X-ray imaging apparatus for communicating with a control apparatus, comprising:
a wireless communication unit configured to communicate with the control apparatus;
a movement stop detection unit configured to detect a movement stop of the X-ray imaging apparatus based on a temporal variation in an RSSI value obtained by said wireless communication unit;
a wireless environment determination unit configured to determine stability of a wireless communication environment based on a magnitude of a value of an S/N ratio of a received signal obtained by said wireless communication unit; and
an output unit configured to output, to the control apparatus, a signal to prohibit an X-ray generation apparatus connected to the control apparatus from performing exposure based on a detection result of said movement stop detection unit and a determination result of said wireless environment determination unit.

9. A method of controlling an X-ray imaging apparatus for communicating with a control apparatus, comprising the steps of:
communicating with the control apparatus;
measuring a first wireless parameter and a second wireless parameter representing a wireless communication environment;
detecting a movement stop of the X-ray imaging apparatus based on a temporal variation in the first wireless parameter;
determining one of stability and instability of the wireless communication environment based on a temporal variation in the second wireless parameter; and
outputting, to the control apparatus, a signal to prohibit an X-ray generation apparatus connected to the control apparatus from performing exposure based on a detection result in the step of detecting and a determination result in the step of determining.

10. A method of controlling an X-ray imaging apparatus for communicating with a control apparatus, comprising the steps of:
communicating with the control apparatus;
detecting a movement stop of the X-ray imaging apparatus based on a temporal variation in an RSSI value obtained in the communicating;
determining stability of a wireless communication environment based on a magnitude of a value of an S/N ratio of a received signal obtained in the communicating; and
outputting, to the control apparatus, a signal to prohibit an X-ray generation apparatus connected to the control apparatus from performing exposure based on a detection result in the detecting and a determination result in the determining.

11. A non-transitory computer-readable storage medium storing a computer program that causes a computer to execute each step of an X-ray imaging apparatus control method described in claim 9.

12. A non-transitory computer-readable storage medium storing a computer program that causes a computer to execute each step of an X-ray imaging apparatus control method described in claim 10.

13. An information processing apparatus for controlling an operation of an X-ray imaging system that wirelessly transmits X-ray image data obtained by an X-ray imaging apparatus to a display apparatus, comprising:
a detection unit configured to detect a parameter representing a wireless communication environment; and
an output unit configured to output a signal to restrict X-ray generation by an X-ray generation apparatus based on a temporal variation in the detected parameter.

14. A method of controlling an information processing apparatus for controlling an operation of an X-ray imaging system that wirelessly transmits X-ray image data obtained by an X-ray imaging apparatus to a display apparatus, comprising the steps of:
detecting a parameter representing a wireless communication environment; and
outputting a signal to restrict X-ray generation by an X-ray generation apparatus based on a temporal variation in the detected parameter.

15. A non-transitory computer-readable storage medium storing a computer program that causes a computer to execute each step of an information processing apparatus control method described in claim 14.
